(19) United States
(12) Patent Application Publication
(10) Pub. No.: US 2022/0222671 A1
(43) Pub. Date: Jul. 14, 2022

(54) Currency, Transaction Management, and Cyber Security Systems Enabling Multiple Entity Split Exchange

(71) Applicant: Reach Enterprises, Inc., Sunnyvale, CA (US)

(72) Inventors: Michael A. Ribero, Palo Alto, CA (US); Robert B. Vance, JR., Issaquah, WA (US); George E. Northup, Redwood City, CA (US); Yosef Becher, Oakland, CA (US)

(21) Appl. No.: 17/569,368

(22) Filed: Jan. 5, 2022

Related U.S. Application Data
(60) Provisional application No. 63/135,442, filed on Jan. 8, 2021.

(51) Int. Cl. G06Q 20/40; G06Q 20/20

(52) U.S. Cl. CPC G06Q 20/4016; G06Q 20/4015; G06Q 20/204

(57) ABSTRACT

Systems and methods for verifying and enabling cross-entity and split exchange for fraud protection are disclosed. Some embodiments may include: receiving, from a Point of Sale (POS) device at a server device, associated member card to Point of Sale data resulting from an associated member card being submitted to the Point of Sale (POS) device for a merchandise or service transaction, the associated member card to a Point of Sale data comprising meta data, card member information, merchant information, purchase information, and location data of the merchandise or service transaction, verifying, using the server device, the location data of the merchandise or service transaction being within permitted locations thereby preventing fraud by blocking transactions at unverified locations, determining, using the server device. Moreover, systems enabling cross-entity and split exchange for fraud protection are disclosed.

### CROSS-REFERENCE TO RELATED APPLICATIONS

This patent application claims the priority benefit of U.S. Provisional Patent Application Ser. No. 63/135,442, filed Jan. 8, 2021. This present patent application is related to, and incorporates by reference, U.S. Nonprovisional patent application Ser. No. 17/521,676, filed Nov. 8, 2021 and U.S. Provisional Patent Application Ser. No. 63/127,757, filed Dec. 18, 2020. All of the aforementioned disclosures are hereby incorporated by reference herein in their entireties including all references and appendices cited therein.

### TECHNICAL FIELD

The present disclosure is directed to systems and methods for providing, managing, authorizing, and verifying and monetizing exchanges across different systems and customer loyalty programs and the reward currencies that drive them. Further, the systems and methods can include processes and methods that minimize merchant/client interactions required for privacy and cyber security requirements and to prevent fraudulent transactions in various embodiments.

### BACKGROUND

A problem with prior customer reward/merchant loyalty programs is that the currency and utility of the programs are so limited that as that they have almost no value. It is often difficult to get what you want, when you want it, and how you want it. Hotels and airlines often have limited availability during popular times of travel. Thus, redeeming, or monetizing credits within a loyalty or rewards program is often not a frictionless process. Additionally, loyalty or reward program credits are not interchangeable with other programs.

A further problem lies with the limitations of the currency and the limited merchandise made available for purchase by virtually all brands with a loyalty program. Because they work outside of the merchant's “mainstream,” what is available is often limited (i.e., consumers typically have to choose from a limited subset of what the brand/merchant offers), and because this inventory is not managed by the same inventory control systems, it is often unavailable when the consumer/member wants it. The ideal solution is to enable the currency to be used to purchase anything the brand offers, but those systems that have attempted to do so requires significant modification to brand/merchant point-of-sale (POS) systems and cannot leverage existing payment networks, making the process difficult and challenging for consumers and brands alike. This is why virtually every brand requires some kind of human intervention to complete a loyalty transaction. Those that don't limit the transaction to online-only, as they cannot afford to train store staff on the use of an alternative or proprietary currency.

Further challenges can occur from privacy restrictions limiting the sharing of member information with and between merchants. Another challenge implementing loyalty programs and system is that when a transaction is split between a credit card and loyalty dollars, it requires two transactions to complete and thereby making the transaction more time consuming and less convenient. Most Point of Sale (POS) terminals do not support split transactions.

What is needed are systems and methods that enables loyalty or reward program credits to be as good as cash. Additionally, what is needed is being able to share loyalty dollars between merchant's and/or brand's loyalty programs. Further, there is a need for systems where loyalty program members have control over their personal data shared with merchants and between merchants within loyalty programs. Also, there is a need is for seamless split transactions on POS terminals not configured for split transactions—transactions utilizing loyalty/reward credits and a credit card—to occur seamlessly for merchants.

The present technology solved all these problems, requires no additional training, and allows use of its currency in-store as well as online. In fact, a card of the present technology can be used along with a discount code or coupon as well as on discounted or close-out items. Anything you can purchase with cash or traditional credit card you can purchase with a card of the present technology.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 illustrates a system configured for verifying and enabling cross-entity and split exchange for fraud protection, according to various embodiments of the present technology.

FIG. 2A, FIG. 2B, FIG. 2C, FIG. 2D, FIG. 2E, FIG. 2F and FIG. 2G illustrate an exemplary method for verifying and enabling cross-entity and split exchange for fraud protection, according to various embodiments of the present technology.

FIG. 3 is a flowchart of an example method of authorizing Point of Sale (POS) transactions that can include loyalty dollars and credit card payments, according to various embodiments of the present technology.

FIG. 4 is a flowchart of fraud protection mechanism return of merchandise purchased with loyalty dollars or loyalty dollars and credit/debit card charges, according to various embodiments of the present technology.

FIG. 5 is a block diagram of an example environment suitable for practicing methods of cross-entity exchange, according to various embodiments of the present technology.

FIG. 6 is a schematic flow diagram, according to various embodiments of the present technology.

FIG. 7 is a diagrammatic representation of an exemplary system in the form of a computer system for executing various embodiments of the present technology.

### DETAILED DESCRIPTION

The present disclosure relates generally to systems and methods for providing, managing, authorizing, and verifying and monetizing exchanges or transactions across different systems. One such system is the monetization of consumer merchant credits that can be encompasses in a member loyalty or rewards programs. For example, a brand or merchant may give a member that has a member card credits for promoting a brand, a referral, the purchasing an item under the brand, or by the sharing person information about themselves with the brand and optionally with other brands or merchants.

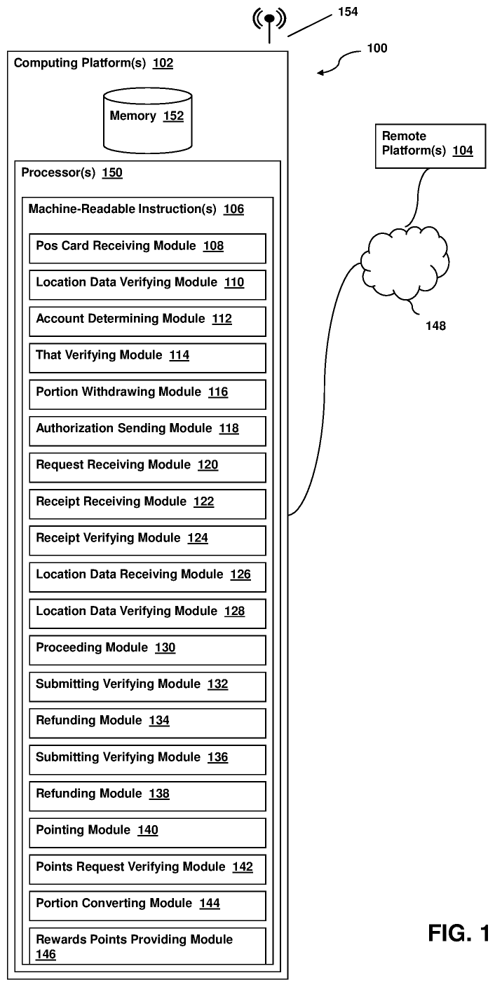

FIG. 1 illustrates a system configured for verifying and enabling cross-entity and split exchange for fraud protection, in accordance with one or more embodiments. In some cases, system 100 may include one or more computing platforms 102. The one or more remote computing platforms 102 may be communicably coupled with one or more remote platforms 104. In some cases, users may access the system 100 via remote platform(s) 104.

The one or more computing platforms 102 may be configured by machine-readable instructions 106. Machine-readable instructions 106 may include modules. The modules may be implemented as one or more of functional logic, hardware logic, electronic circuitry, software modules, and the like. The modules may include one or more of pos card receiving module 108, location data verifying module 110, account determining module 112, that verifying module 114, portion withdrawing module 116, authorization sending module 118, request receiving module 120, receipt receiving module 122, receipt verifying module 124, location data receiving module 126, location data verifying module 128, proceeding module 130, submitting verifying module 132, refunding module 134, submitting verifying module 136, refunding module 138, pointing module 140, points request verifying module 142, portion converting module 144, rewards points providing module 146, and/or other modules.

POS card receiving module 108 may be configured to receive, from a Point of Sale (POS) device at a server device, associated member card to Point of Sale data resulting from an associated member card being submitted to the Point of Sale (POS) device for a merchandise or service transaction, the associated member card to a Point of Sale data comprising meta data, card member information, merchant information, purchase information, and location data of the merchandise or service transaction. Location data verifying module 110 may be configured to verify, using the server device, the location data of the merchandise or service transaction be within permitted locations thereby preventing fraud by blocking transactions at unverified locations. Account determining module 112 may be configured to determine, using the server device, an account of the associated member card include a first portion of a card points to complete the merchandise or service transaction, the first portion of the card points being insufficient to complete the merchandise or service transaction. That verifying module 114 may be configured to verify, using the server device, that the account of the associated member card have a corresponding credit card or debit card connected with the associated member card to complete a second portion of card points to complete the merchandise or service transaction, the second portion of the card points being sufficient to complete the merchandise or service transaction. Portion withdrawing module 116 may be configured to submitting, using the server device, a split exchange, the split exchange being withdraw the first portion of the card points from the account of the associated member card and simultaneously charging funds to the corresponding credit card or debit card connected with the associated member card for the second portion of card points to complete the merchandise or service transaction. Authorization sending module 118 may be configured to send, using the server device, an authorization for the merchandise or service transaction to the Point of Sale (POS) device based on the split exchange.

Request receiving module 120 may be configured to receive a request for a refund for the merchandise or service transaction. Receipt receiving module 122 may be configured to receive a receipt for the merchandise or service transaction connected with the request for the refund of the merchandise or service transaction the card member information and the purchase information. Receipt verifying module 124 may be configured to verify the receipt by matching the associated member card to a Point of Sale data comprising the meta data the merchant information the card member information and the purchase information from the Point of Sale (POS) device.

Location data receiving module 126 may be configured to receive location data of the merchandise or service transaction associated with the request for the refund. Location data verifying module 128 may be configured to verify the location data of the merchandise or service transaction associated with the request for the refund by comparing the location data of the merchandise or service transaction associated with the request for the refund with the and location data of the merchandise or service transaction from the Point of Sale (POS) device. Proceeding module 130 may be configured to proceed with fulfillment of the request for a refund for the merchandise or service transaction based on the verifying of the location data of the merchandise or service transaction associated with the request for the refund.

Submitting verifying module 132 may be configured to verify the submitting of the split exchange. Refunding module 134 may be configured to refund upon the verifying of the submitting of the split exchange, the first portion of the card points to the account of the associated member card.

Submitting verifying module 136 may be configured to verify the submitting of the split exchange. Refunding module 138 may be configured to refund upon the verifying of the submitting of the split exchange, the charging funds to the corresponding credit card or debit card connected with the associated member card for the second portion of card points to complete the merchandise or service transaction.

Pointing module 140 may be configured to receiving a transaction points conversion request, the transaction point conversion request being a request to convert the first portion of the card points to complete the merchandise or service transaction to currency. Points request verifying module 142 may be configured to verify the transaction points conversion request using the associated member card to a Point of Sale data comprising the meta data the merchant information and the location data of the merchandise or service transaction. Portion converting module 144 may be configured to convert the first portion of the card points to complete the merchandise or service transaction to currency upon the verifying of the transaction points conversion request.

Rewards points providing module 146 may be configured to provide rewards points to the account of the associated member card based on the submitting of the split exchange, the split exchange being withdraw the first portion of the card points from the account of the associated member card and simultaneously charging funds to the corresponding credit card or debit card connected with the associated member card for the second portion of card points to complete the merchandise or service transaction.

In some cases, the one or more computing platforms 102, may be communicatively coupled to the remote platform(s) 104. In some cases, the communicative coupling may include communicative coupling through a networked environment 148. The networked environment 148 may be a radio access network, such as LTE or 5G, a local area network (LAN), a wide area network (WAN) such as the Internet, or wireless LAN (WLAN), for example. It will be appreciated that this is not intended to be limiting, and that the scope of this disclosure includes implementations in which one or more computing platforms 102 and remote platform(s) 104 may be operatively linked via some other communication coupling. The one or more one or more computing platforms 102 may be configured to communicate with the networked environment 148 via wireless or wired connections. In addition, in an embodiment, the one or more computing platforms 102 may be configured to communicate directly with each other via wireless or wired connections. Examples of one or more computing platforms 102 may include, but is not limited to, smartphones, wearable devices, tablets, laptop computers, desktop computers, Internet of Things (IoT) device, or other mobile or stationary devices. In an embodiment, system 100 may also include one or more hosts or servers, such as the one or more remote platforms 104 connected to the networked environment 148 through wireless or wired connections. According to one embodiment, remote platforms 104 may be implemented in or function as base stations (which may also be referred to as Node Bs or evolved Node Bs (eNBs)). In other embodiments, remote platforms 104 may include web servers, mail servers, application servers, and the like. According to certain embodiments, remote platforms 104 may be standalone servers, networked servers, or an array of servers.

The one or more computing platforms 102 may include one or more processors 150 for processing information and executing instructions or operations. One or more processors 150 may be any type of general or specific purpose processor. In some cases, multiple processors 150 may be utilized according to other embodiments. In fact, the one or more processors 150 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples. In some cases, the one or more processors 150 may be remote from the one or more computing platforms 102, such as disposed within a remote platform like the one or more remote platforms 104 of FIG. 1.

The one or more processors 150 may perform functions associated with the operation of system 100 which may include, for example, precoding of antenna gain/phase parameters, encoding and decoding of individual bits forming a communication message, formatting of information, and overall control of the one or more computing platforms 102, including processes related to management of communication resources.

The one or more computing platforms 102 may further include or be coupled to a memory 152 (internal or external), which may be coupled to one or more processors 150, for storing information and instructions that may be executed by one or more processors 150. Memory 152 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 152 can consist of any combination of random-access memory (RAM), read only memory (ROM), static storage such as a magnetic or optical disk, hard disk drive (HDD), or any other type of non-transitory machine or computer readable media. The instructions stored in memory 152 may include program instructions or computer program code that, when executed by one or more processors 150, enable the one or more computing platforms 102 to perform tasks as described herein.

In some embodiments, one or more computing platforms 102 may also include or be coupled to one or more antennas 154 for transmitting and receiving signals and/or data to and from one or more computing platforms 102. The one or more antennas 154 may be configured to communicate via, for example, a plurality of radio interfaces that may be coupled to the one or more antennas 154. The radio interfaces may correspond to a plurality of radio access technologies including one or more of LTE, 5G, WLAN, Bluetooth, near field communication (NFC), radio frequency identifier (RFID), ultrawideband (UWB), and the like. The radio interface may include components, such as filters, converters (for example, digital-to-analog converters and the like), mappers, a Fast Fourier Transform (FFT) module, and the like, to generate symbols for a transmission via one or more downlinks and to receive symbols (for example, via an uplink).

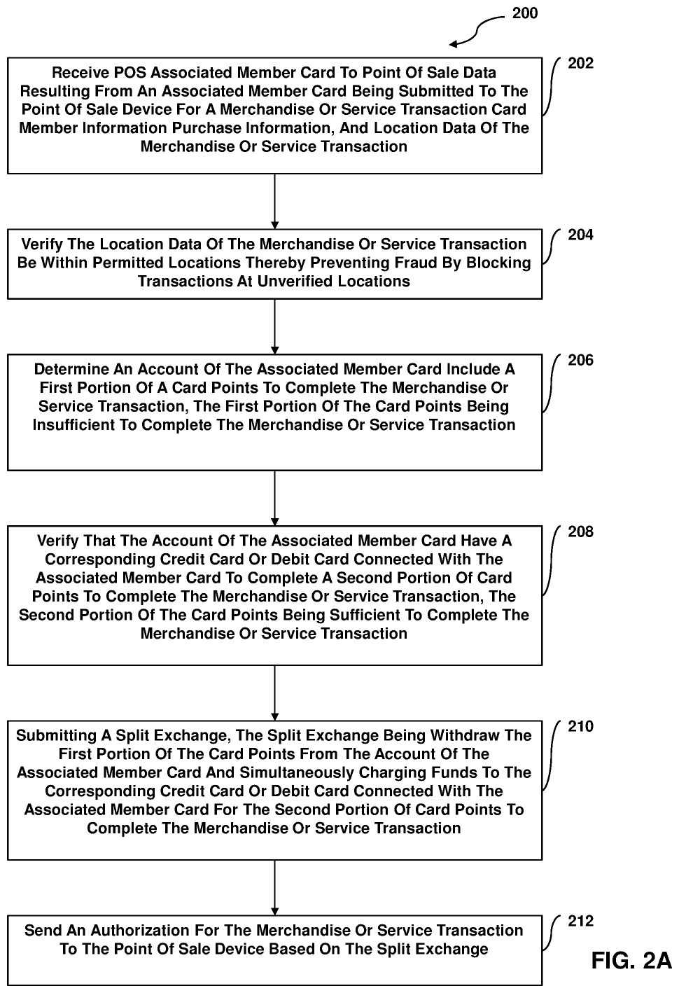

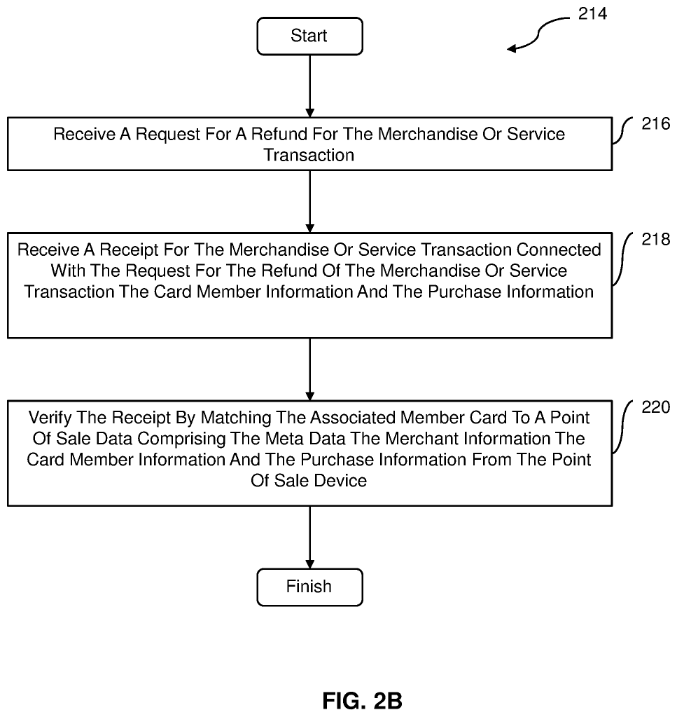

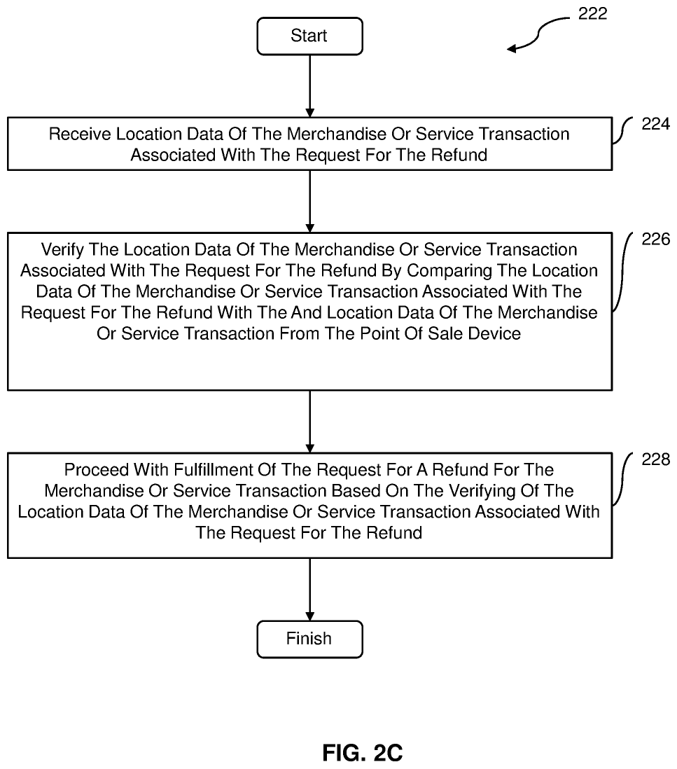

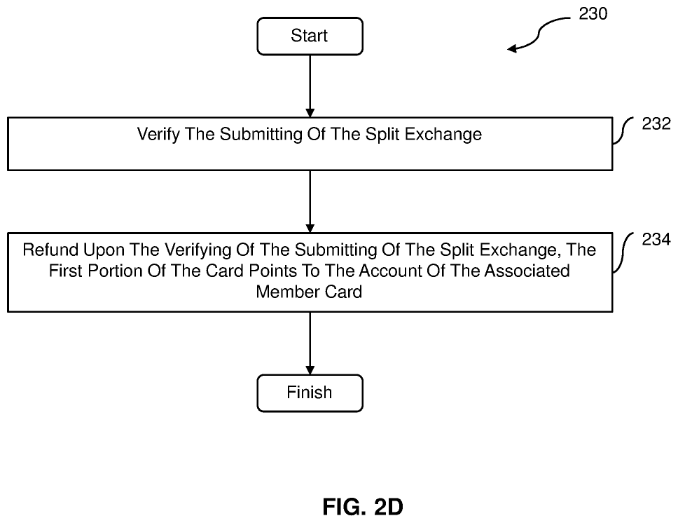

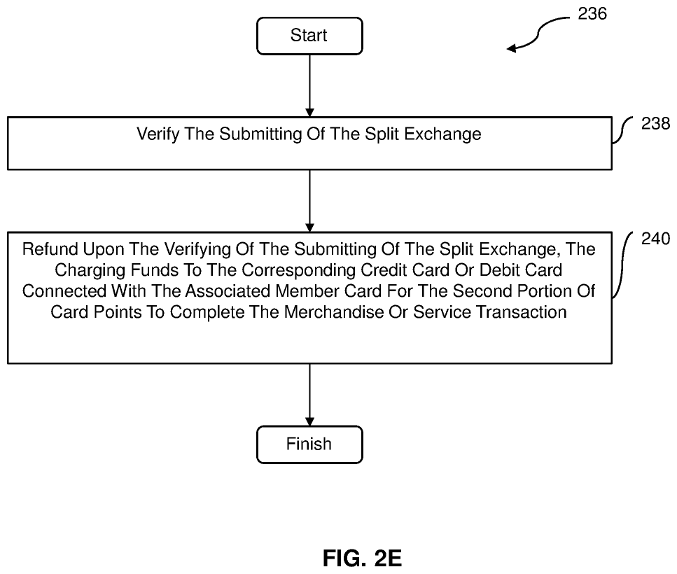

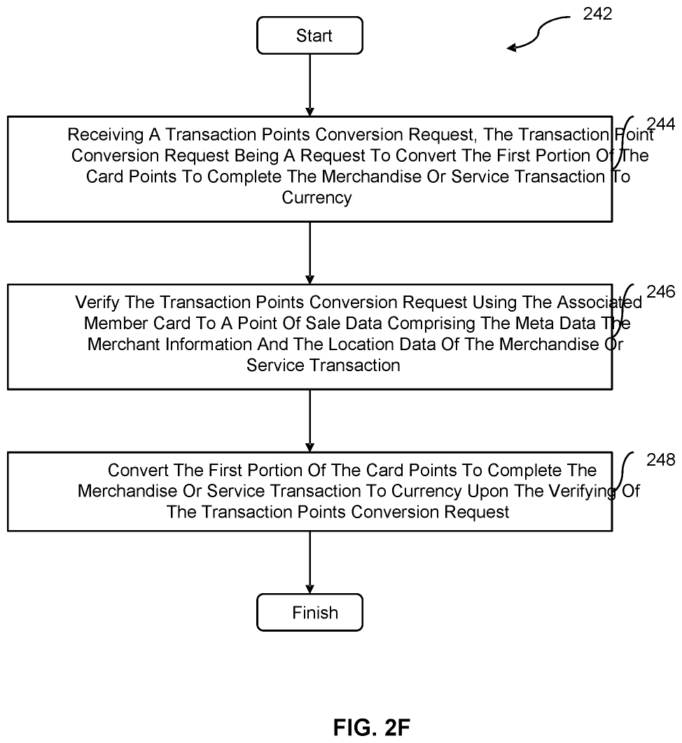

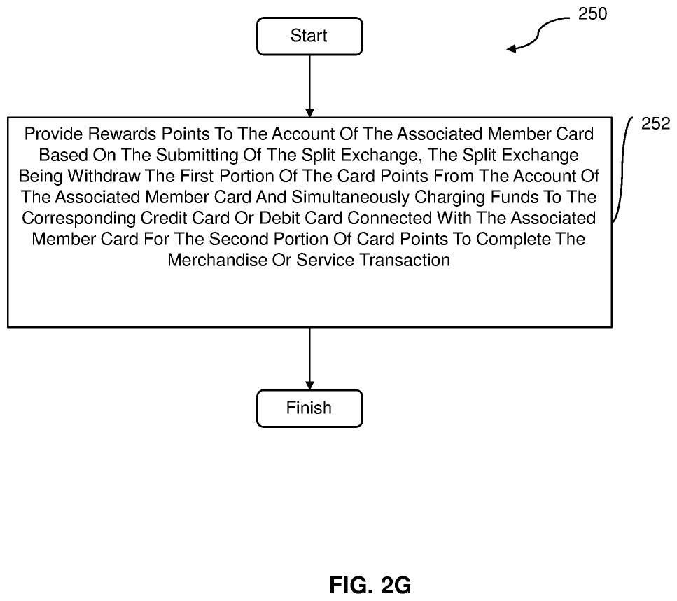

FIG. 2A, FIG. 2B, FIG. 2C, FIG. 2D, FIG. 2E, FIG. 2F and/or FIG. 2G illustrate an example flow diagram of a method 200, according to one embodiment. The method 200 may include receiving, from a Point of Sale (POS) device at a server device, associated member card to Point of Sale data resulting from an associated member card being submitted to the Point of Sale (POS) device for a merchandise or service transaction, the associated member card to a Point of Sale data comprising meta data, card member information, merchant information, purchase information, and location data of the merchandise or service transaction at block 202. The method 200 may include verifying, using the server device, the location data of the merchandise or service transaction being within permitted locations thereby preventing fraud by blocking transactions at unverified locations at block 204. The method 200 may include determining, using the server device, an account of the associated member card including a first portion of a card points to complete the merchandise or service transaction, the first portion of the card points being insufficient to complete the merchandise or service transaction at block 206. The method 200 may include verifying, using the server device, that the account of the associated member card having a corresponding credit card or debit card connected with the associated member card to complete a second portion of card points to complete the merchandise or service transaction, the second portion of the card points being sufficient to complete the merchandise or service transaction at block 208. The method 200 may include submitting, using the server device, a split exchange, the split exchange being withdrawing the first portion of the card points from the account of the associated member card and simultaneously charging funds to the corresponding credit card or debit card connected with the associated member card for the second portion of card points to complete the merchandise or service transaction at block 210. The method 200 may include sending, using the server device, an authorization for the merchandise or service transaction to the Point of Sale (POS) device based on the split exchange at block 212.

In FIG. 2B, the method 200 may be continued at 214, and may further include receiving a request for a refund for the merchandise or service transaction at block 216. The method 200 continued at 214 may further include receiving a receipt for the merchandise or service transaction connected with the request for the refund of the merchandise or service transaction the card member information and the purchase information at block 218. The method 200 continued at 214 may also further include verifying the receipt by matching the associated member card to a Point of Sale data comprising the meta data the merchant information the card member information and the purchase information from the Point of Sale (POS) device at block 220.

In FIG. 2C, the method 200 may be continued at 222, and may further include receiving location data of the merchandise or service transaction associated with the request for the refund at block 224. The method 200 continued at 222 may further include verifying the location data of the merchandise or service transaction associated with the request for the refund by comparing the location data of the merchandise or service transaction associated with the request for the refund with the and location data of the merchandise or service transaction from the Point of Sale (POS) device at block 226. The method 200 continued at 222 may also further include proceeding with fulfillment of the request for a refund for the merchandise or service transaction based on the verifying of the location data of the merchandise or service transaction associated with the request for the refund at block 228.

In FIG. 2D, the method 200 may be continued at 230, and may further include verifying the submitting of the split exchange at block 232. The method 200 continued at 230 may also further include refunding upon the verifying of the submitting of the split exchange, the first portion of the card points to the account of the associated member card at block 234.

In FIG. 2E, the method 200 may be continued at 236, and may further include verifying the submitting of the split exchange at block 238. The method 200 continued at 236 may also further include refunding upon the verifying of the submitting of the split exchange, the charging funds to the corresponding credit card or debit card connected with the associated member card for the second portion of card points to complete the merchandise or service transaction at block 240.

In FIG. 2F, the method 200 may be continued at 242, and may further include receiving a transaction points conversion request, the transaction pointing conversion request being a request to convert the first portion of the card points to complete the merchandise or service transaction to currency at block 244. The method 200 continued at 242 may further include verifying the transaction points conversion request using the associated member card to a Point of Sale data comprising the meta data the merchant information and the location data of the merchandise or service transaction at block 246. The method 200 continued at 242 may also further include converting the first portion of the card points to complete the merchandise or service transaction to currency upon the verifying of the transaction points conversion request at block 248.

In FIG. 2G, the method 200 may be continued at 250, and may further include providing rewards points to the account of the associated member card based on the submitting of the split exchange, the split exchange being withdrawing the first portion of the card points from the account of the associated member card and simultaneously charging funds to the corresponding credit card or debit card connected with the associated member card for the second portion of card points to complete the merchandise or service transaction at block 252.

In some cases, the method 200 may be performed by one or more hardware processors, such as the processors 150 of FIG. 1, configured by machine-readable instructions, such as the machine-readable instructions 106 of FIG. 1. In this aspect, the method 200 may be configured to be implemented by the modules, such as the modules 108, 110, 112, 114, 116, 118, 120, 122, 124, 126, 128, 130, 132, 134, 136, 138, 140, 142, 144 and/or 146 discussed above in FIG. 1.

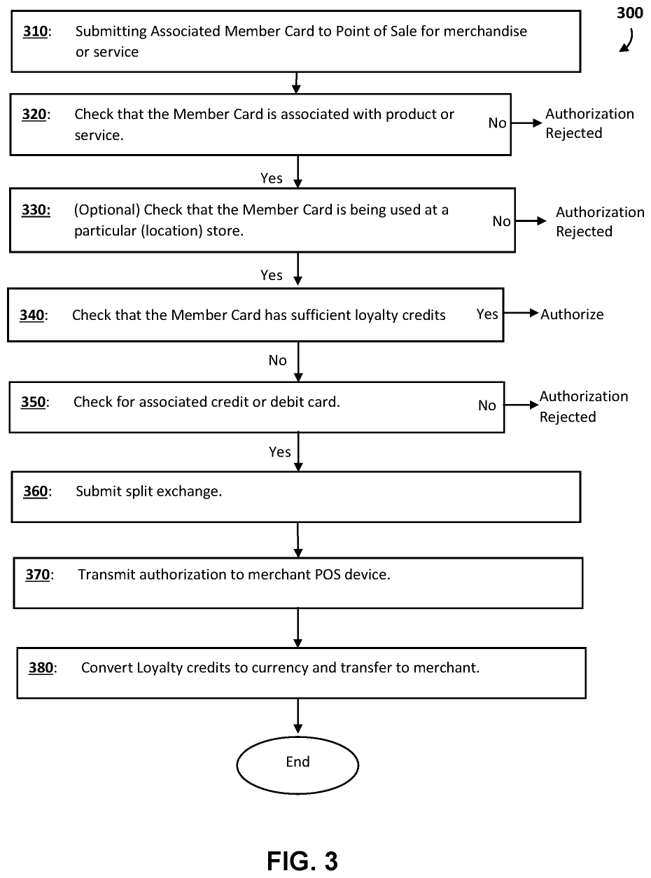

FIG. 3 is one embodiment of an exchange between entities having particular constraints with each entity. FIG. 3 is an example of a method 300 by which a member of a loyalty program, merchant, merchant payment processor, a card service provider, and a loyalty program authorizing service processes exchanges.

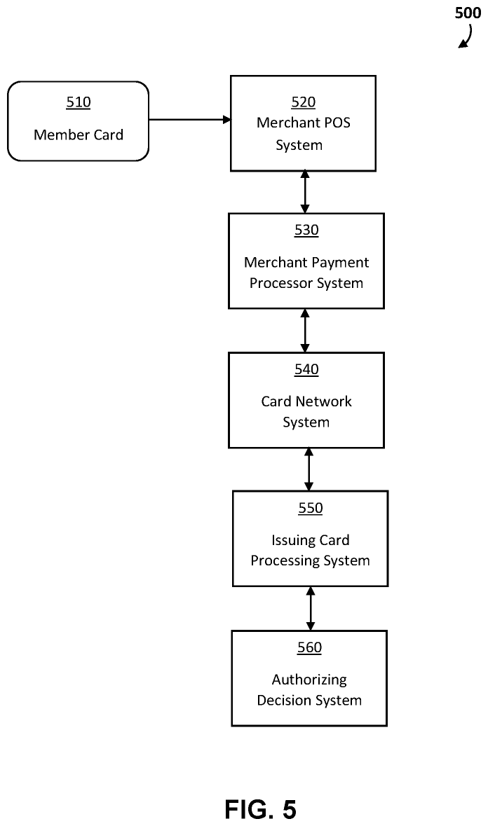

In a first step 310, a member's loyalty/reward card is submitted to a merchant Point Of Sale (POS) reader for a merchandise or service transaction. For example, a POS refers to the place where a customer executes the payment for goods or services (e.g., uses loyalty/reward points and/or a debit or credit card) and where sales taxes may become payable. A POS may be in a physical store, where POS terminals and systems are used to process card payments or a virtual sales point such as a computer or mobile electronic device. The member's card is associated with one or more merchant loyalty programs that can be managed by a back-end server referred to as the Authorization and Decision System (See 560—FIG. 5). A merchant loyalty/reward program can be associated with a product brand, a merchant chain, a particular store within a merchant chain, or an individual store. Further, there can be an association with a credit card or debit and thereby supporting split transactions. The transaction can be for merchandise or services associated with the loyalty program, but the exchange can use credits earned from purchases made for merchandise or services from associated loyalty programs. Associated loyalty program are programs where the brand, merchant chain, or stores agree to the association and allows for loyalty/rewards credits earned through one merchant or brand to be used to use acquire merchandise of a different merchant.

The POS reads meta data off the card that is associated with the merchant loyalty program. The meta data, card member information, merchant information and purchase information is transmitted from the POS for processing. The meta data can be sent to a merchant payment processing system for further processing.

In a step 320, a processing system receives processes the meta data, card member information, merchant data, and information about the product or services being exchanged. The processing system can be a merchant processing system, or this step can occur in the backend (e.g., Authorizing Decision System 560 of FIG. 5). In this step, an assessment can be performed. The first level of assessment is part of a hierarchy of checks to prevent fraud in a cross-system exchange or a refund. The first assessment is to verify that the product or service being purchased matches the brand with which the consumer has loyalty/reward credits.

The transmission of the data between service providers, Merchant Payment processing system, Card Network System, Issuing Card Processing System, and Authorizing Decision System can be over a public or private network and be performed as a service by a server that may be performing this service for many different merchants. One commercial source providing such Merchant Payment Processing services is “CyberSource.” “Cybersource” is an E-commerce credit card payment system management company. Customers process online payments, streamline online fraud management, and simplify payment security. After processing the received data, the data is sent to card network.

In a step 330, the Issuing Card Payment process receives the meta data, vendor data and data related to the merchant loyalty/reward program. An example of an issuing card payment processor is VISA® or MASTERCARD®, and the like, which provides these types of processing services. The Issuing Card Payment Processing service sends the transaction request to a backend server that has access to information regarding credits for the card. In this step a check can be made on whether the transaction is occurring at a specific location and thereby limiting the location where the card credits can be used. This can provide a fraud protection features in that by use being location based, a clone of a member's card could not be used the credits outside the country or state or with any other merchant. The location can be a particular store, retail outlet and for a particular brand.

This location check can occur anywhere along the processing path on any of the processing systems but preferably occurs at the Authorizing Decision system.

In a step 340, a check is made on whether the loyalty credits associated with the card member are sufficient to cover the exchange or transaction. If the loyalty credits are sufficient, then the exchange is authorized. The card member loyalty credits are debited, and authorization is sent back to the merchant's POS to complete the exchange. The Member Card account will be deducted by the amount of exchange credits authorized.

This check can occur when an Issuing Card Payment Processor system sends a request for an authorization. The request can include an identifier for the card member, and the merchandise being exchanged for loyalty credits and location of the merchant. Preferably, this check is performed by a server configured to manage the exchange of royalty credits in a POS member card system.

The method step 340 is reached if there are not sufficient member card loyalty/credits associated with the card to complete the exchange or transaction with the POS card system. A further check is performed to determine if there is a credit card or debit card, or other financial exchange mechanism associated with the card member's account. The check can occur by multiple different protocols. The protocol can include a response indicating that there is insufficient loyalty credit for the exchange, but split transaction processing is supported. Alternatively, a response indicating that there is insufficient loyalty credits, and the Issuing Card Processing System could issue a request for a split transaction. The response to the Issuing Card Processing System could then indicate that either split processing was or was not supported.

In the method step 350, a check is made of whether there is a credit or debit card associated with the member's card. This step is only reached if there is insufficient member's loyalty/reward credits for the merchandise being authorized. If there is not a credit or debit card associated with the member's card, then authorization for the exchange/transaction will be declined.

If there is a credit or debit card associated with the member card, then a step 360, a split exchange is submitted. The submission can come from an Issuing Card Processing system. Within the member's card account, the credits associated with the merchandise or brand are debited from the account and remaining amount to be exchanged is charged to the credit or debit card associated with that member's account.

To complete the exchange, in a step 370, an authorization is transmitted to the merchant POS device. This authorization can pass through multiple systems including the Issuing Card Processing system, the Card Network, the Merchant Payment system, and finally to the POS device.

In a final step 380, the merchant will receive a settlement amount for the credits and any charges against the member's associated credit card.

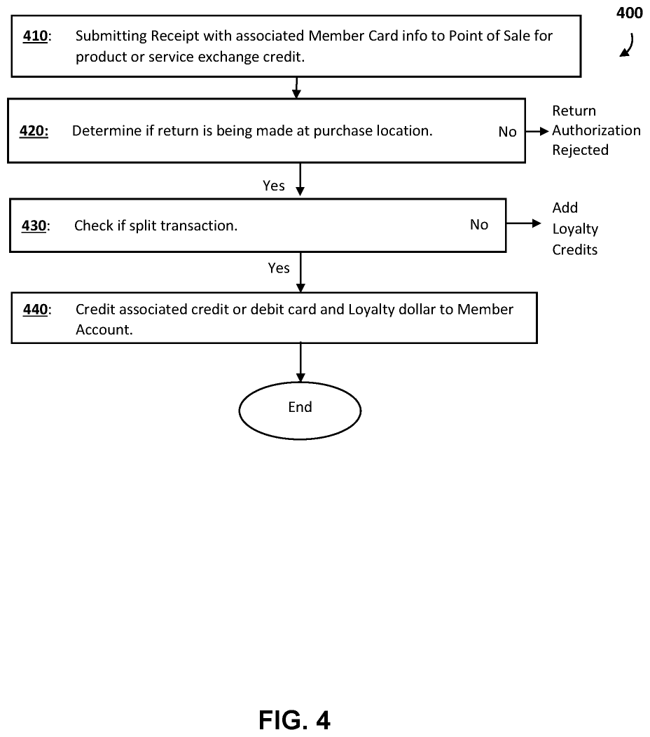

FIG. 4 is one embodiment of a method 400 for refunding an exchange that occurred across entities. Beneficially, this method reduces fraud by limiting returns to members, the location where the merchandise was received, and only for loyalty/reward credits and credit and debit card refunds. The process assumes that a cross-entity exchange has been previously made and that the Authorization and Decision service or another service has recorded the transaction. The transaction can include an identifier of the member's card, the item purchased, and how and if the transaction was split between loyalty credits and credit or debit card payments. Additionally, the information presented in the refund process can include the location of the exchange.

In a step 410, a receipt that can include the member's card identifier, a merchandise identifier, and the item that was the subject of the exchanges is evaluated. This information can be input into a merchant's POS system where it is processed by another service and is received by the Authorization and Decision service.

In a step 420, location of where the exchange/transaction occurred, and the location of the return is evaluated. Various limits can be applied, the same store, the same city, or the same chain. If the location criteria are not met, then the return transaction is denied. If the location criteria are met, processing the return/refund continues.

Next the transaction history for the member card is checked for a split exchange/transaction 430. If it was not a split transaction, then the member's card account is credited the full return amount as loyalty/reward points. If there was not a split transaction, then the account associated with the member card is credited the corresponding loyalty/reward credits.

If there was a split exchange or transaction, then in a step 440 both loyalty/reward credits and the credit card is credited to the member's account for the transaction.

FIG. 5 is an example schematic diagram of an architecture 500 for practicing aspects or embodiments of the present disclosure. The architecture 500 may comprise the following system components of a Member Card 510, a Merchant POS system 520, a Merchant Payment Processor system 530, a Card Network system 540, an Issuing Card Processing system 550, and an Authorizing Decision System 560.

The member card 510 includes a member identifier number and is configured to be readable by Merchant POS system 520 typically found at a merchant shop. This can include magnetic strips or an RFID chip. On the Authorizing Decision System 560, there is configured an associated account for that card member identifier number. This can be part of a database and processing server. Associated with that account can be loyalty/reward credits and optionally an identifier for a credit or debit card that can be used within a split transaction. Additionally, for each member can be information regarding what information about the member is authorized to be shared with merchants and brands.

The Merchant POS system 520 read Member Card and sends a transaction requests to the Merchant Payment Processor system 530. In response the Merchant POS system 520 will receive authorizations and denials of transactions from the Merchant Payment Processor system.

The Merchant Payment Processor system 530 receives transactions from the Merchant POS system 520 and sends transaction requests to and receives authorizations from the Card Network system 540. An example of this type of system includes a credit card company such as VISA® or MASTERCARD®, and the like (e.g., an Issuing Card Payment Processing service). The Card Network system 540 can do a first level of risk assessment on a transaction where it is possible that a denial is generated at this point.

The Card Network system 540 receives exchange/transaction requests from the Merchant Payment Processor system 530 the then forwards transaction requests and receives authorizations or denials from the Issuing Card Processing system 550. Often this is run by a bank that may have issued the card. Here the Issuing Card Processing system 550 can apply further business rules to the transaction.

The Issuing Card Processing system 550, by evaluating the Member card identifier, will then send the transaction information to the Authorizing Decision System 560. The Authorizing Decision System 560 can be a back-end server that operates on a separate server than any of the other processing systems or service. The Authorizing Decision System 560 maintains a database of member cards, manages associated loyalty credits, manages returns and credits to a card member account, and responds to transaction request received. Further, the Authorizing Decision System 560 handles and authorizes split transactions where loyalty and a credit card is used to compete an exchange/transaction.

In one embodiment, the Authorizing Decision System 560 will receive a request for a transaction originating from the Merchant POS system 520. The Authorizing Decision System 560 may implement the processes described above within the methods described in FIG. 4 and FIG. 5. In some embodiments, the Authorizing Decision System 560 uses of an Artificial Intelligence (AI) driven rules engine to determine a portion of a transaction to be paid by each of three parties involved. For example, first, a consumer/member making the purchase; second, the brand making the sale; and third, Reach. For example, systems of the present technology may pay the sales tax, provide a discount, or pay for shipping, based on the consumer's/member's prior activity for a specific order. Moreover, a similar scenario same could also go for the brand making the sale of the specific transaction.

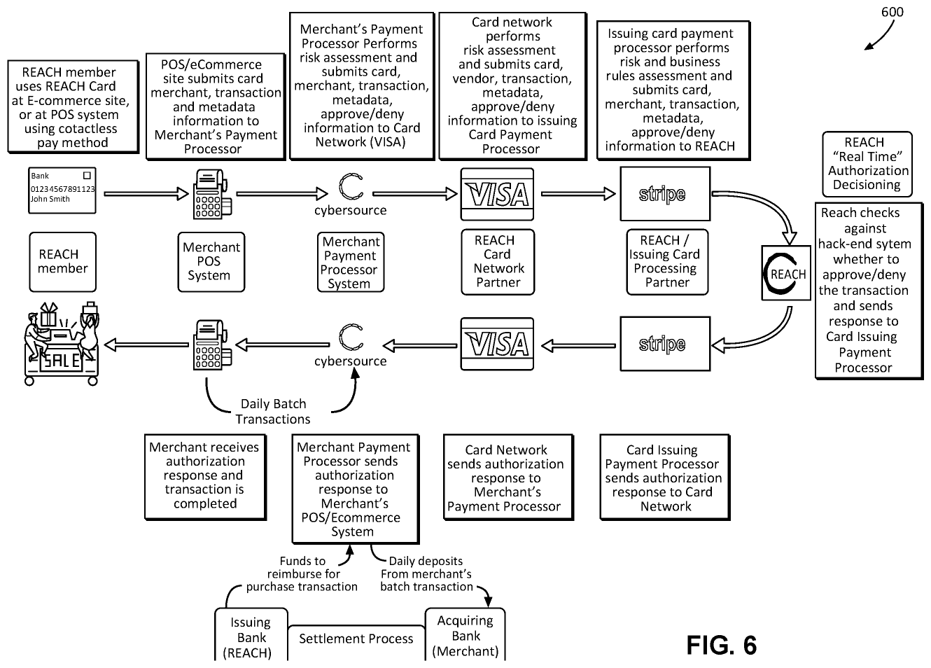

FIG. 6 is a schematic flow diagram, according to various embodiments of the present technology. For example, FIG. 6 is another schematic diagram of the processing flow 600 for practicing aspects or embodiments of the present disclosure. FIG. 6 shows an example process flow (e.g., the processing flow 600) according to exemplary embodiments.

### Examples

Example 1 includes a system comprising: receiving, from a Point of Sale (POS) device at a server device, associated member card to Point of Sale data resulting from an associated member card being submitted to the Point of Sale (POS) device for a merchandise or service transaction, the associated member card to a Point of Sale data comprising meta data, card member information, merchant information, purchase information, and location data of the merchandise or service transaction, verifying, using the server device, the location data of the merchandise or service transaction being within permitted locations thereby preventing fraud by blocking transactions at unverified locations, determining, using the server device, an account of the associated member card including a first portion of a card points to complete the merchandise or service transaction, the first portion of the card points being insufficient to complete the merchandise or service transaction, verifying, using the server device, that the account of the associated member card having a corresponding credit card or debit card connected with the associated member card to complete a second portion of card points to complete the merchandise or service transaction, the second portion of the card points being sufficient to complete the merchandise or service transaction, submitting, using the server device, a split exchange, the split exchange being withdrawing the first portion of the card points from the account of the associated member card and simultaneously charging funds to the corresponding credit card or debit card connected with the associated member card for the second portion of card points to complete the merchandise or service transaction and sending, using the server device, an authorization for the merchandise or service transaction to the Point of Sale (POS) device based on the split exchange.

Example 2 includes the system of example(s) 1 and/or some other example(s) herein, further comprising: receiving, at the server device, a request for a refund for the merchandise or service transaction; receiving, at the server device, a receipt for the merchandise or service transaction connected with the request for the refund of the merchandise or service transaction, the receipt including the associated member card to a Point of Sale data comprising the meta data, the card member information, the merchant information, and the purchase information; and verifying, at the server device, the receipt by matching the associated member card to a Point of Sale data comprising the meta data, the card member information, the merchant information, and the purchase information from the receipt matches the associated member card to a Point of Sale data comprising the meta data, the card member information, the merchant information, and the purchase information from the Point of Sale (POS) device.

Example 3 includes the system of example(s) 2 and/or some other example(s) herein, further comprising: receiving, at the server device, location data of the merchandise or service transaction associated with the request for the refund; verifying, at the server device, the location data of the merchandise or service transaction associated with the request for the refund by comparing the location data of the merchandise or service transaction associated with the request for the refund with the and location data of the merchandise or service transaction from the Point of Sale (POS) device; and proceeding, using the server device, with fulfillment of the request for a refund for the merchandise or service transaction based on the verifying of the location data of the merchandise or service transaction associated with the request for the refund.

Example 4 includes the system of example(s) 3 and/or some other example(s) herein, further comprising: verifying, using the server device, the submitting of the split exchange; and refunding, using the server device, upon the verifying of the submitting of the split exchange, the first portion of the card points to the account of the associated member card.

Example 5 includes the system of example(s) 4 and/or some other example(s) herein, further comprising: verifying, using the server device, the submitting of the split exchange; and refunding, using the server device, upon the verifying of the submitting of the split exchange, the charging funds to the corresponding credit card or debit card connected with the associated member card for the second portion of card points to complete the merchandise or service transaction.

Example 6 includes the system of example(s) 1 and/or some other example(s) herein, further comprising: receiving, at the server device from the Point of Sale (POS) device, a transaction points conversion request, the transaction pointing conversion request being a request to convert the first portion of the card points to complete the merchandise or service transaction to currency; verifying, at the server device, the transaction points conversion request using the associated member card to a Point of Sale data comprising the meta data, the card member information, the merchant information, the purchase information, and the location data of the merchandise or service transaction; converting, at the server device, the first portion of the card points to complete the merchandise or service transaction to currency upon the verifying of the transaction points conversion request.

Example 7 includes the system of example(s) 1 and/or some other example(s) herein, further comprising: providing, using the server device, rewards points to the account of the associated member card based on the submitting of the split exchange, the split exchange being withdrawing the first portion of the card points from the account of the associated member card and simultaneously charging funds to the corresponding credit card or debit card connected with the associated member card for the second portion of card points to complete the merchandise or service transaction.

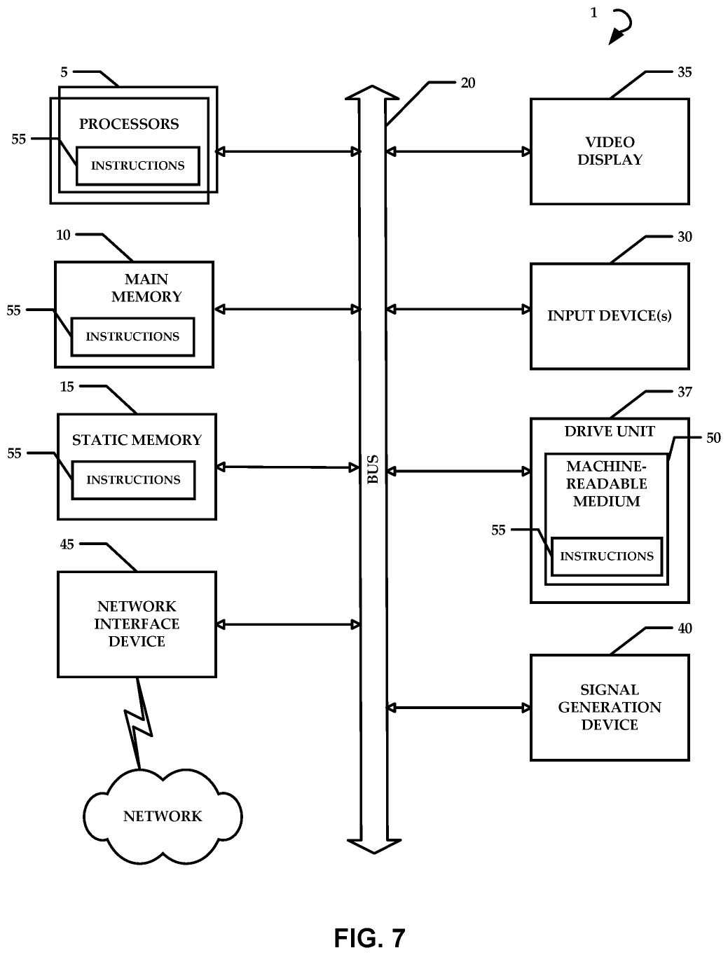

FIG. 7 is a diagrammatic representation of an exemplary system in the form of a computer system 1, within which a set of instructions for causing the machine to perform any one or more of the methodologies discussed herein may be executed. In various example embodiments, the machine operates as a standalone device or may be connected (e.g., networked) to other machines. It could be executed within a Customer Relations Management (“CRM”) system. In some cases, the systems and methods herein may send an API call to Salesforce or the like. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a smart speaker like Echo or Google Home, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The disk drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. Exemplary embodiments were chosen and described in order to best explain the principles of the present disclosure and its practical application, and to enable others of ordinary skill in the art to understand the present disclosure for various embodiments with various modifications as are suited to the particular use contemplated.

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present disclosure. As such, some of the components may have been distorted from their actual scale for pictorial clarity.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It is noted at the outset that the terms “coupled,” “connected”, “connecting,” “electrically connected,” etc., are used interchangeably herein to generally refer to the condition of being electrically/electronically connected. Similarly, a first entity is considered to be in “communication” with a second entity (or entities) when the first entity electrically sends and/or receives (whether through wireline or wireless means) information signals (whether containing data information or non-data/control information) to the second entity regardless of the type (analog or digital) of those signals. It is further noted that various figures (including component diagrams) shown and discussed herein are for illustrative purpose only, and are not drawn to scale.

While specific embodiments of, and examples for, the system are described above for illustrative purposes, various equivalent modifications are possible within the scope of the system, as those skilled in the relevant art will recognize. For example, while processes or steps are presented in a given order, alternative embodiments may perform routines having steps in a different order, and some processes or steps may be deleted, moved, added, subdivided, combined, and/or modified to provide alternative or sub-combinations. Each of these processes or steps may be implemented in a variety of different ways. Also, while processes or steps are at times shown as being performed in series, these processes or steps may instead be performed in parallel, or may be performed at different times.

While various embodiments have been described above, it should be understood that they have been presented by way of example only, and not limitation. The descriptions are not intended to limit the scope of the invention to the particular forms set forth herein. To the contrary, the present descriptions are intended to cover such alternatives, modifications, and equivalents as may be included within the spirit and scope of the invention as defined by the appended claims and otherwise appreciated by one of ordinary skill in the art. Thus, the breadth and scope of a preferred embodiment should not be limited by any of the above-described exemplary embodiments.

What is claimed is:

1. A system of verifying and enabling cross-entity and split exchange for fraud protection, comprising:
one or more hardware processors configured by machine-readable instructions to:
receive, from a Point of Sale (POS) device at a server device, associated member card to Point of Sale data resulting from an associated member card being submitted to the Point of Sale (POS) device for a merchandise or service transaction, the associated member card to Point of Sale data comprising meta data, card member information, merchant information, purchase information, and location data of the merchandise or service transaction;
verify, using the server device, the location data of the merchandise or service transaction be within permitted locations thereby preventing fraud by blocking transactions at unverified locations;
determine, using the server device, an account of the associated member card include a first portion of a card points to complete the merchandise or service transaction, the first portion of the card points being insufficient to complete the merchandise or service transaction;
verify, using the server device, that the account of the associated member card have a corresponding credit card or debit card connected with the associated member card to complete a second portion of card points to complete the merchandise or service transaction, the second portion of the card points being sufficient to complete the merchandise or service transaction;
submit, using the server device, a split exchange, the split exchange being withdraw the first portion of the card points from the account of the associated member card and simultaneously charging funds to the corresponding credit card or debit card connected with the associated member card for the second portion of card points to complete the merchandise or service transaction; and
send, using the server device, an authorization for the merchandise or service transaction to the Point of Sale (POS) device based on the split exchange.

2. The system of verifying and enabling cross-entity and split exchange for fraud protection of claim 1, wherein the one or more hardware processors are further configured by machine-readable instructions to:
receive, at the server device, a request for a refund for the merchandise or service transaction;
receive, at the server device, a receipt for the merchandise or service transaction connected with the request for the refund of the merchandise or service transaction, the receipt including the associated member card to Point of Sale data comprising the meta data, the card member information, the merchant information, and the purchase information; and
verify, at the server device, the receipt by matching the associated member card to Point of Sale data comprising the meta data, the card member information, the merchant information, and the purchase information from the receipt matches the associated member card to Point of Sale data comprising the meta data, the card member information, the merchant information, and the purchase information from the Point of Sale (POS) device.

3. The system of verifying and enabling cross-entity and split exchange for fraud protection of claim 2, wherein the one or more hardware processors are further configured by machine-readable instructions to:
receive, at the server device, location data of the merchandise or service transaction associated with the request for the refund;
verify, at the server device, the location data of the merchandise or service transaction associated with the request for the refund by comparing the location data of the merchandise or service transaction associated with the request for the refund with the and location data of the merchandise or service transaction from the Point of Sale (POS) device; and
proceed, using the server device, with fulfillment of the request for a refund for the merchandise or service transaction based on the verifying of the location data of the merchandise or service transaction associated with the request for the refund.

4. The system of verifying and enabling cross-entity and split exchange for fraud protection of claim 3, wherein the one or more hardware processors are further configured by machine-readable instructions to:
verify, using the server device, the submitting of the split exchange; and
refund, using the server device, upon the verifying of the submitting of the split exchange, the first portion of the card points to the account of the associated member card.

5. The system of verifying and enabling cross-entity and split exchange for fraud protection of claim 4, wherein the one or more hardware processors are further configured by machine-readable instructions to:
verify, using the server device, the submitting of the split exchange; and
refund, using the server device, upon the verifying of the submitting of the split exchange, the charging funds to the corresponding credit card or debit card connected with the associated member card for the second portion of card points to complete the merchandise or service transaction.

6. The system of verifying and enabling cross-entity and split exchange for fraud protection of claim 1, wherein the one or more hardware processors are further configured by machine-readable instructions to:
receiving, at the server device from the Point of Sale (POS) device, a transaction points conversion request, the transaction point conversion request being a request to convert the first portion of the card points to complete the merchandise or service transaction to currency;
verify, at the server device, the transaction points conversion request using the associated member card to Point of Sale data comprising the meta data, the card member information, the merchant information, the purchase information, and the location data of the merchandise or service transaction; and
convert, at the server device, the first portion of the card points to complete the merchandise or service transaction to currency upon the verifying of the transaction points conversion request.

7. The system of verifying and enabling cross-entity and split exchange for fraud protection of claim 1, wherein the one or more hardware processors are further configured by machine-readable instructions to: provide, using the server device, rewards points to the account of the associated member card based on the submitting of the split exchange, the split exchange being withdraw the first portion of the card points from the account of the associated member card and simultaneously charging funds to the corresponding credit card or debit card connected with the associated member card for the second portion of card points to complete the merchandise or service transaction.

8. A method of verifying and enabling cross-entity and split exchange for fraud protection, the method comprising:
receiving, from a Point of Sale (POS) device at a server device, associated member card to Point of Sale (POS) data resulting from an associated member card being submitted to the Point of Sale (POS) device for a merchandise or service transaction, the associated member card to a Point of Sale (POS) data comprising meta data, card member information, merchant information, purchase information, and location data of the merchandise or service transaction;
verifying, using the server device, the location data of the merchandise or service transaction is within permitted locations thereby preventing fraud by blocking transactions at unverified locations;
determining, using the server device, an account of the associated member card includes a first portion of a card points to complete the merchandise or service transaction, the first portion of the card points being insufficient to complete the merchandise or service transaction;
verifying, using the server device, that the account of the associated member card has a corresponding credit card or debit card connected with the associated member card to complete a second portion of card points to complete the merchandise or service transaction, the second portion of the card points being sufficient to complete the merchandise or service transaction;
submitting, using the server device, a split exchange, the split exchange being withdrawing the first portion of the card points from the account of the associated member card and simultaneously charging funds to the corresponding credit card or debit card connected with the associated member card for the second portion of card points to complete the merchandise or service transaction; and
sending, using the server device, an authorization for the merchandise or service transaction to the Point of Sale (POS) device based on the split exchange.

9. The method of verifying and enabling cross-entity and split exchange for fraud protection of claim 8, further comprising:
receiving, at the server device, a request for a refund for the merchandise or service transaction;
receiving, at the server device, a receipt for the merchandise or service transaction connected with the request for the refund of the merchandise or service transaction, the receipt including the associated member card to a Point of Sale (POS) data comprising the meta data, the card member information, the merchant information, and the purchase information; and
verifying, at the server device, the receipt by matching the associated member card to a Point of Sale (POS) data comprising the meta data, the card member information, the merchant information, and the purchase information from the receipt matches the associated member card to a Point of Sale (POS) data comprising the meta data, the card member information, the merchant information, and the purchase information from the Point of Sale (POS) device.

10. The method of verifying and enabling cross-entity and split exchange for fraud protection of claim 9, further comprising:
receiving, at the server device, location data of the merchandise or service transaction associated with the request for the refund;
verifying, at the server device, the location data of the merchandise or service transaction associated with the request for the refund by comparing the location data of the merchandise or service transaction associated with the request for the refund with the and location data of the merchandise or service transaction from the Point of Sale (POS) device; and
proceeding, using the server device, with fulfillment of the request for a refund for the merchandise or service transaction based on the verifying of the location data of the merchandise or service transaction associated with the request for the refund.

11. The method of verifying and enabling cross-entity and split exchange for fraud protection of claim 10, further comprising:
verifying, using the server device, the submitting of the split exchange; and
refunding, using the server device, upon the verifying of the submitting of the split exchange, the first portion of the card points to the account of the associated member card.

12. The method of verifying and enabling cross-entity and split exchange for fraud protection of claim 11, further comprising:
verifying, using the server device, the submitting of the split exchange; and
refunding, using the server device, upon the verifying of the submitting of the split exchange, the charging funds to the corresponding credit card or debit card connected with the associated member card for the second portion of card points to complete the merchandise or service transaction.

13. The method of verifying and enabling cross-entity and split exchange for fraud protection of claim 8, further comprising:
receiving, at the server device from the Point of Sale (POS) device, a transaction points conversion request, the transaction points conversion request being a request to convert the first portion of the card points to complete the merchandise or service transaction to currency;
verifying, at the server device, the transaction points conversion request using the associated member card to a Point of Sale (POS) data comprising the meta data, the card member information, the merchant information, the purchase information, and the location data of the merchandise or service transaction; and
converting, at the server device, the first portion of the card points to complete the merchandise or service transaction to currency upon the verifying of the transaction points conversion request.

14. The method of verifying and enabling cross-entity and split exchange for fraud protection of claim 8, further comprising:
providing, using the server device, rewards points to the account of the associated member card based on the submitting of the split exchange, the split exchange being withdrawing the first portion of the card points from the account of the associated member card and simultaneously charging funds to the corresponding credit card or debit card connected with the associated member card for the second portion of card points to complete the merchandise or service transaction.

15. A non-transient computer-readable storage medium for verifying and enabling cross-entity and split exchange for fraud protection comprising instructions being executable by one or more processors to perform a method, the method comprising:
receiving, from a Point of Sale (POS) device at a server device, associated member card to Point of Sale data resulting from an associated member card being submitted to the Point of Sale (POS) device for a merchandise or service transaction, the associated member card to a Point of Sale data comprising meta data, card member information, merchant information, purchase information, and location data of the merchandise or service transaction;
verifying, using the server device, the location data of the merchandise or service transaction is within permitted locations thereby preventing fraud by blocking transactions at unverified locations;
determining, using the server device, an account of the associated member card includes a first portion of a card points to complete the merchandise or service transaction, the first portion of the card points being insufficient to complete the merchandise or service transaction;
verifying, using the server device, that the account of the associated member card has a corresponding credit card or debit card connected with the associated member card to complete a second portion of card points to complete the merchandise or service transaction, the second portion of the card points being sufficient to complete the merchandise or service transaction;
submitting, using the server device, a split exchange, the split exchange being withdrawing the first portion of the card points from the account of the associated member card and simultaneously charging funds to the corresponding credit card or debit card connected with the associated member card for the second portion of card points to complete the merchandise or service transaction; and
sending, using the server device, an authorization for the merchandise or service transaction to the Point of Sale (POS) device based on the split exchange.

16. The computer-readable storage medium for verifying and enabling cross-entity and split exchange for fraud protection of claim 15, wherein the at least one memory and the computer program code are further configured to, with the processor, cause the computer-readable storage medium to receive, at the server device, a request for a refund for the merchandise or service transaction;
receive, at the server device, a receipt for the merchandise or service transaction connected with the request for the refund of the merchandise or service transaction, the receipt including associated member card to Point of Sale data comprising the meta data, the card member information, the merchant information, and the purchase information; and
verify, at the server device, the receipt by matching associated member card to Point of Sale data comprising the meta data, the card member information, the merchant information, and the purchase information from the receipt matches the associated member card to a Point of Sale data comprising the meta data, the card member information, the merchant information, and the purchase information from Point of Sale (POS) device.

17. The computer-readable storage medium for verifying and enabling cross-entity and split exchange for fraud protection of claim 16, wherein the at least one memory and the computer program code are further configured to, with the processor, cause the computer-readable storage medium to receive, at the server device, location data of the merchandise or service transaction associated with the request for the refund;
verify, at the server device, the location data of the merchandise or service transaction associated with the request for the refund by comparing the location data of the merchandise or service transaction associated with the request for the refund with the and location data of the merchandise or service transaction from the Point of Sale (POS) device; and
proceed, using the server device, with fulfillment of the request for a refund for the merchandise or service transaction based on the verifying of the location data of the merchandise or service transaction associated with the request for the refund.

18. The computer-readable storage medium for verifying and enabling cross-entity and split exchange for fraud protection of claim 17, wherein the at least one memory and the computer program code are further configured to, with the processor, cause the computer-readable storage medium to verify, using the server device, the submitting of the split exchange; and
refund, using the server device, upon the verifying of the submitting of the split exchange, the first portion of the card points to the account of the associated member card.

19. The computer-readable storage medium for verifying and enabling cross-entity and split exchange for fraud protection of claim 18, wherein the at least one memory and the computer program code are further configured to, with the processor, cause the computer-readable storage medium to verify, using the server device, the submitting of the split exchange; and
refund, using the server device, upon the verifying of the submitting of the split exchange, the charging funds to the corresponding credit card or debit card connected with the associated member card for the second portion of card points to complete the merchandise or service transaction.

20. The computer-readable storage medium for verifying and enabling cross-entity and split exchange for fraud protection of claim 15, wherein the at least one memory and the computer program code are further configured to, with the processor, cause the computer-readable storage medium to receiving, at the server device from the Point of Sale (POS) device, a transaction points conversion request, the transaction point conversion request being a request to convert the first portion of the card points to complete the merchandise or service transaction to currency;
verify, at the server device, the transaction points conversion request using the associated member card to a Point of Sale data comprising the meta data, the card member information, the merchant information, the purchase information, and the location data of the merchandise or service transaction; and
convert, at the server device, the first portion of the card points to complete the merchandise or service transaction to currency upon the verifying of the transaction points conversion request.

21. The computer-readable storage medium for verifying and enabling cross-entity and split exchange for fraud protection of claim 15, wherein the at least one memory and the computer program code are further configured to, with the processor, cause the computer-readable storage medium to provide, using the server device, rewards points to the account of the associated member card based on the submitting of the split exchange, the split exchange being withdraw the first portion of the card points from the account of the associated member card and simultaneously charging funds to the corresponding credit card or debit card connected with the associated member card for the second portion of card points to complete the merchandise or service transaction.
